(19) United States
(12) Patent Application Publication
(10) Pub. No.: US 2014/0114814 A1
(43) Pub. Date: Apr. 24, 2014

(54) INVENTORY USE UP ON MATERIAL LOCATION LEVEL

(71) Applicants: Olgert Lindau, Heidelberg (DE); Markus Reipp, Reilingen (DE)

(72) Inventors: Olgert Lindau, Heidelberg (DE); Markus Reipp, Reilingen (DE)

(73) Assignee: SAP AG, Walldorf (DE)

(21) Appl. No.: 13/658,616

(22) Filed: Oct. 23, 2012

(51) Int. Cl. G06Q 10/08

(52) U.S. Cl. 705/28

(57) ABSTRACT

A system determines usage of material inventory stored in different physical locations. Material inventory at the physical locations is determined. Material inventory usage settings of the material inventory at the physical locations are determined. A tree data structure is generated for usage of the material inventory at the physical locations based on the material inventory usage settings. The tree data structure is traversed to locate material inventory from the physical locations to satisfy a material usage request using the material inventory usage settings. Physical locations and corresponding material inventory usage are identified.

### FIELD

The present disclosure relates generally to data analysis, and in a specific example embodiment, to inventory usage based on material location level.

### BACKGROUND

Conventionally, a manufacturing planning process orders supplies from inventories as supplies are needed. Material needed in the manufacturing of a product may be transported from different inventory locations. Repeated and ineffective transportation of material from different inventory locations can result in increased costs and time and may adversely affect the manufacturing process of a product.

### BRIEF DESCRIPTION OF DRAWINGS

The appended drawings merely illustrate example embodiments of the present invention and cannot be considered as limiting its scope.

FIG. 1A is a block diagram illustrating an example of a system in which embodiments may be practiced.

FIG. 1B is a block diagram illustrating an example embodiment of a tree data structure generator.

FIG. 1C is a block diagram illustrating an example embodiment of a material locator module.

FIG. 2 is a diagram illustrating an example of a tree data structure of material inventory at different physical locations.

FIG. 3 is a flowchart of a method, in accordance with an example embodiment, for generating a tree of material locations.

FIG. 4 is a flowchart of a method, in accordance with an example embodiment, for locating materials using the tree of FIG. 3.

FIG. 5 is a block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments. It will be evident, however, to those skilled in the art that embodiments of the inventive subject matter may be practiced without these specific details. In general, well-known instruction instances, protocols, structures, and techniques have not been shown in detail.

Examples of a system and method for locating material inventory for use at different physical locations are described. In one example embodiment, an example system determines usage of material inventory stored in different physical locations. Material inventory at the physical locations is determined. Material inventory usage settings of the material inventory at the physical locations are determined. A tree data structure is generated for usage of the material inventory at the physical locations based on the material inventory usage settings. The tree data structure is traversed to locate material inventory from the physical locations to satisfy a material usage request using the material inventory usage settings. Physical locations and corresponding material inventory usage are identified.

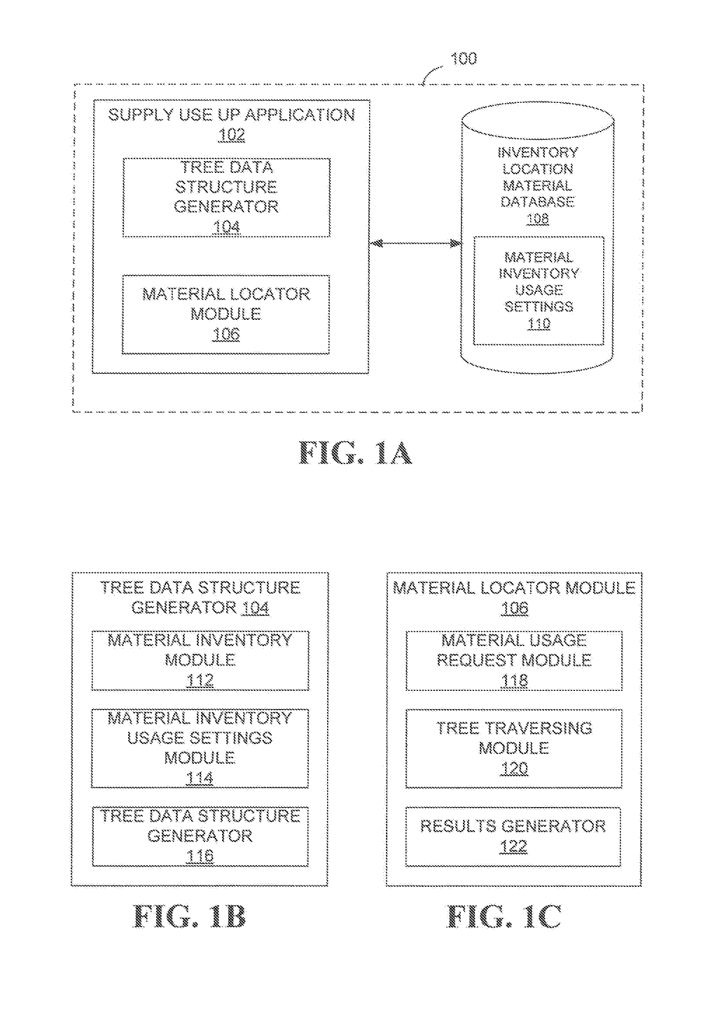

With reference to FIG. 1, a system 100 in which example embodiments may be practiced is shown. The system 100 comprises a supply use up application 102 that is communicatively coupled to an inventory location material database 108. The supply use up application 102 may help identify and locate material inventory located at different physical locations such as factory warehouses in response a material usage request. The supply use up application 102 may reside in a computer such as a server. Other computer systems may also be communicatively coupled via a network to the supply use up application 102 or the system 100. The network may comprise, for example, one or more of a wired or wireless network, a local area network (LAN), or a wide area network (WAN). While the example embodiment of FIG. 1 shows supply use up application 102 in one server system, alternative embodiments may contemplate the various components of the supply use up application 102 and the database 108 being embodied within several systems (e.g., cloud computing system, server farm system).

In one embodiment, the supply use up application 102 includes a tree data structure generator 104 and a material locator module 106. The tree data structure generator 104 generates a tree data structure corresponding to the material inventory in corresponding physical locations. The material locator module 106 identifies the physical locations and a quantity of material from the identified physical locations that may be used to satisfy a material usage request.

An example of a production or a manufacturing process includes several stages such as goods received, transportation to warehouses, stock in warehouse, release from stock, supply to manufacturing line, production process, packaging of goods produced. As such, providing material to the manufacturing line in a timely and efficient manner helps improve the production process. The supply use application 102 helps identify and locate material inventory from warehouses to be supplied to the manufacturing line. In one example scenario, a particular component may be needed to manufacture a product. The particular component is stocked in different warehouses located at different distances from the manufacturing plant. The supply use up application 102 may help identify the number of particular components from respective warehouses to be shipped to the manufacturing plant and used in manufacturing the product. For example, the tree data structure generator 104 may generate a tree data structure corresponding to the inventory of the component at the different warehouse locations. The material locator module 106 may identify which warehouse to obtain the component from, and bow many components are needed from the corresponding identified warehouses.

The database 108 may store material inventory at the different physical locations, and material inventory usage settings 110. For example, the material inventory usage settings 110 include settings on how to identify the physical locations for material requested from a production process. In one embodiment, the material inventory usage settings 110 may include a breadth setting and a depth setting. The breadth setting may include a priority setting corresponding to each branch of the tree data structure. The depth setting may include a use-up setting of a physical location. The priority setting may include a priority order for material inventory usage at the corresponding physical location. The use-up setting may include a depth inventory usage corresponding to the branch of the physical location.

FIG. 1B is a block diagram illustrating an example embodiment of the tree data structure generator 104 of FIG. 1 . The tree data structure generator 104 includes a material inventory module 112, a material inventory usage settings module 114, and a tree data structure generator 116.

If The material inventory module 112 determines material inventory at the physical locations. For example, the material inventory module 112 identifies which components or materials are stocked or located in physical warehouses. In another example, the physical warehouses may be networked to one another to represent a tree architecture corresponding to a business organization. For example, a main factory where items are produced has a warehouse located next door. Smaller factories related to the main factory may be located at different distances. Each smaller factory may or may not have its own warehouse to store a number of components.

The material inventory usage settings module 114 determines material inventory usage settings for the material inventory at the different physical locations. As previously discussed, the material inventory usage settings include settings on how to identify the physical locations for requested material. In one embodiment, the material inventory usage settings may include a breadth setting and a depth setting. The breadth setting may include a priority setting corresponding to each branch of the tree data structure. The depth setting may include a use-up setting of a physical location.

The priority setting may include a priority order for material inventory usage at the corresponding physical location. For example, the breadth setting may order and prioritize which branch of the tree data structure to process first, second, and so forth. If a factory has three warehouses, the breadth setting identifies the order in which to check the warehouses for a component.

The use-up setting may include a depth inventory usage corresponding to the branch of the physical location. For example, if a no use-up setting is assigned to a warehouse, sub warehouses of that warehouse are checked for the component instead of moving on to the next warehouse in the next tree branch according to the priority order.

The tree data structure generator 116 generates a tree data structure of a supply chain for usage of the material inventory at the physical locations based on the material inventory usage settings. In one embodiment, the tree data structure has a root node (e.g., a factory) and a plurality of children nodes (e.g., warehouses). The root node may correspond to a primary physical location such a factory, an assembly plant, or a processing plant. The children nodes correspond to secondary physical locations distinct from the primary physical location such as warehouses, sub warehouses, sub factory, satellite factory, and so forth.

FIG. 1C is a block diagram illustrating an example embodiment of the material locator module 106 of FIG. 1A. The material locator module 106 includes a material usage request module 118, a tree traversing module 120, and a results generator 122.

The material usage request module 118 receives a material usage request. For example, a factory may request for a particular number of components.

The tree traversing module 120 traverses the tree data structure to locate material inventory from the physical locations to satisfy the material usage request using the material inventory usage settings. In particular, the tree traversing module 120 identifies physical locations and corresponding material inventory usage. For example, the tree traversing module 120 may identify which warehouses and how much material to obtain from the corresponding warehouses.

The results generator 122 generates results comprising the identified physical locations and corresponding material inventory usage. For example, the results generator 122 may identify the warehouses and the amount of material needed from the corresponding warehouses.

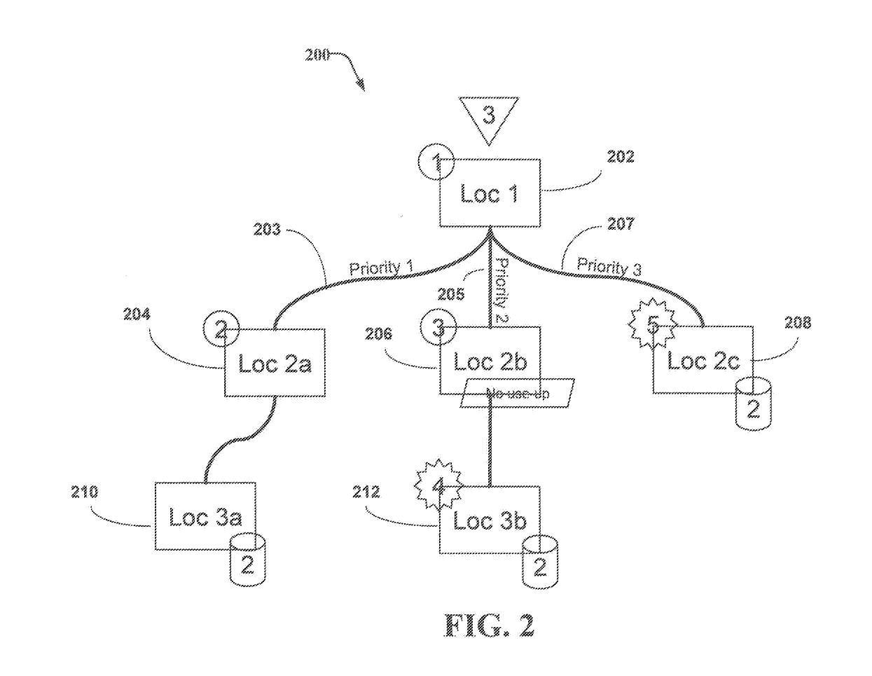

FIG. 2 is a diagram illustrating an example of a tree data structure 200 of material inventory at different physical locations. The tree data structure 200 represents an organized structure of a network of physical locations storing components (e.g., warehouses, factories, sub warehouses, satellite warehouse, local stock, and so forth). For example, location 202 represents, for example, a first factory. A first branch 203 of the tree data structure 200 is represented with locations 204, 210. Location 204 represents, for example, a second factory with its corresponding warehouse at location 210. A second branch 205 of the tree data structure 200 is represented with locations 206,212. Location 206 represents, for example, a third factory with its corresponding warehouse at location 212. A third branch 207 of the tree data structure 200 is represented with location 208. Location 208 represents, for example, a fourth factory. Each location may or may not house or store the different components. For example, location 210 stores two units of a component A. Location 212 stores two units of the component A. Location 208 stores two units of the component A.

The material inventory usage settings may indicate that when searching for components, branch 203 has the first priority, branch 205 has the second priority, and branch 207 has the third priority. Furthermore, the material inventory usage settings may indicate that location 206 is a “no use-up location”.

In the example of FIG. 2, location 202 puts in a request for three units of component A. The tree traversing module 120 traverses the tree data structure 200 following the material inventory usage settings corresponding to the tree data structure 200. Location 204 from branch 203 is first examined to determine whether any component A is stored in location 204 based on the priority of branch 203. The tree traversing module 120 next examines location 206 from branch 205 based on the priority of branch 205. It should be noted that the tree traversing module 120 does not examine location 210 under branch 203 but remains at the same level of location 204.

Because location 206 has a “no use-up location” setting, the tree traversing module 120 further goes down the same branch 205 and examines location 212 for component A. There at location 212, the tree traversing module 120 determines that there are only two units of component A and that another unit is needed. The tree traversing module 120 then goes back to location 208 of the next branch 207 to examine whether there are enough of component A. There at location 208, the tree traversing module 120 determines that one unit of component A can be ordered from location 208.

As such, the tree traversing module 120 traversed the tree data structure 200 in the following order: location 202, location 204, location 206, location 212, and location 208.

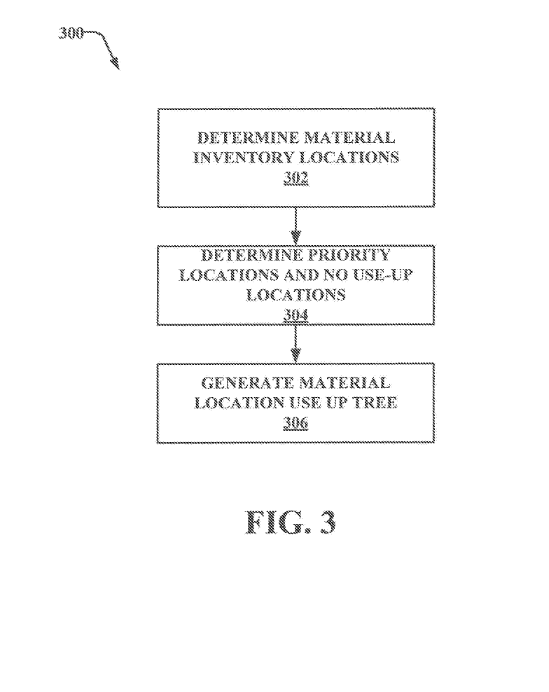

FIG. 3 is a flowchart of a method, in accordance with an example embodiment, for generating a tree of material locations. At operation 302, material inventory at the corresponding physical locations are determined. For example, the material inventory module 112 of the tree data structure generator 104 may perform the operation of determining the material inventory at the corresponding physical locations.

At operation 304, material inventory usage settings of the material inventory at the physical locations are determined. For example, the material inventory usage settings module 114 of the tree data structure generator 104 may perform the operation of determining the material inventory usage settings of the material inventory at the physical locations.

At operation 306, a tree data structure is generated for usage of the material inventory at the physical locations based on the material inventory usage settings. For example, the tree data structure generator 116 of the tree data structure generator 104 may perform the operation of generating the tree data structure.

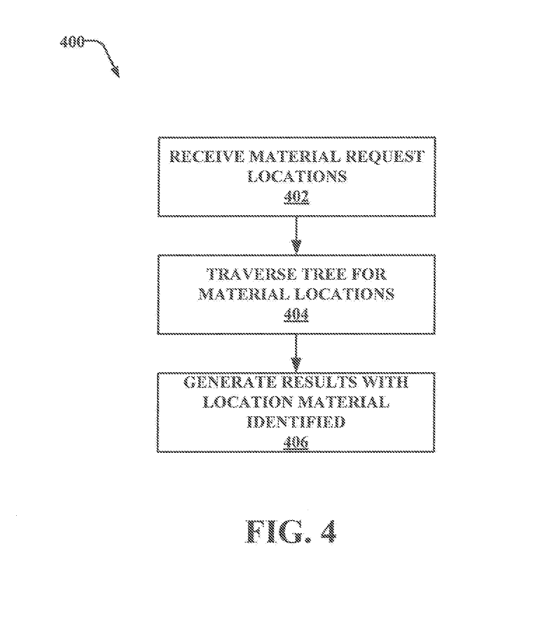

FIG. 4 is a flowchart of a method 400, in accordance with an example embodiment, for locating materials using the tree generated through the method 300 of FIG. 3. At operation 402, a material usage request is received. For example, the material usage request module 118 of the material locator module 106 may perform the operation of receiving a material usage request.

At operation 404, the tree data structure is traversed to locate material inventory from the plurality of physical locations to satisfy the material usage request using the material inventory usage settings. Physical locations and corresponding material inventory usage are identified. For example, the tree traversing module 120 of the material locator module 106 may perform the operation of locating material inventory from the plurality of physical locations to satisfy the material usage request using the material inventory usage settings.

At operation 406, results comprising the identified physical locations and corresponding material inventory usage are generated. For example, the results generator 122 of the material locator module 106 may perform the operation of generating results comprising identifying the physical locations and the corresponding number of units to satisfy the material usage request.

In another embodiment traversing the tree data structure includes traversing across the children nodes in an order according to their corresponding priority setting, traversing down the branch of a child node after detecting a no use-up setting at the child node, and traversing across the children nodes after traversing down the branch of the child node.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

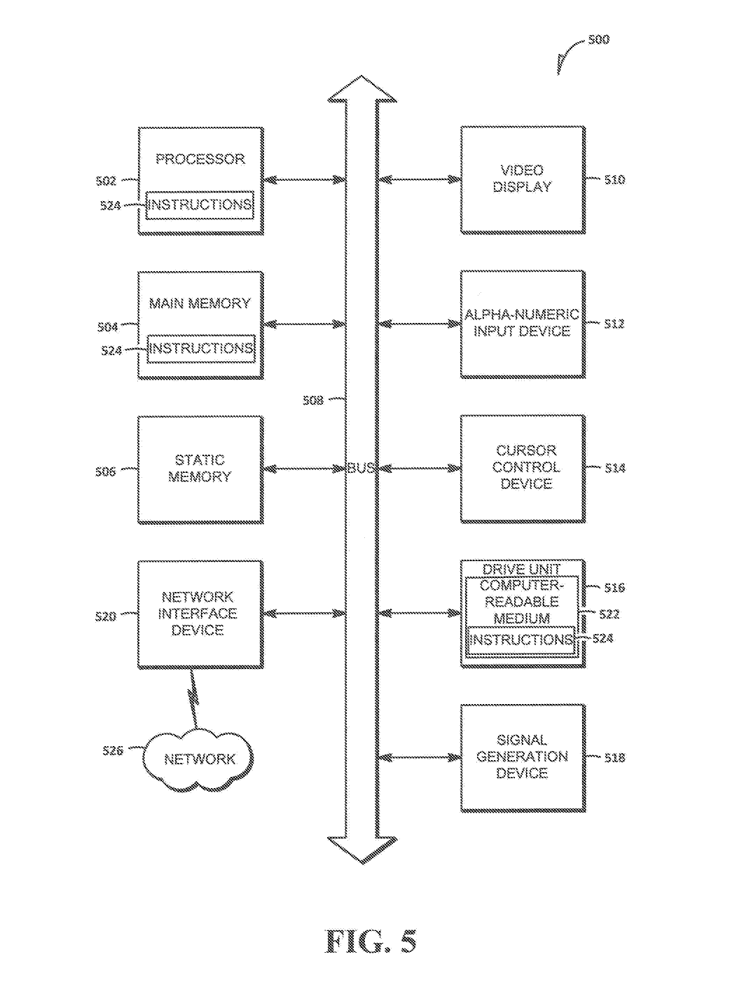

With reference to FIG. 5, an example embodiment extends to a machine in the example form of a computer system 500 within which instructions 524 for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, a server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 may include a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). In example embodiments, the computer system 500 also includes one or more of an alpha-numeric input device 5.12 (e.g., a keyboard), a user interface (UI) navigation device or cursor control device 514 (e.g., a mouse), a disk drive unit 516, a signal generation device 518 (e.g., a speaker), and a network interface device 520.

The disk drive unit 516 includes a computer-readable storage medium 522 on which is stored one or more sets of instructions 524 and data structures (e.g., software instructions) embodying or used by any one or more of the methodologies or functions described herein. The instructions 524 may also reside, completely or at least partially, within the main memory 504 or within the processor 502 during execution thereof by the computer system 500, the main memory 504 and the processor 502 also constituting machine-readable media.

While the computer-readable storage medium 522 is shown in an exemplary embodiment to be a single medium, the term “computer-readable storage medium” may include a single storage medium or multiple media (e.g., a centralized or distributed database, or associated caches and servers) that store the one or more instructions 524. The term “computer-readable storage medium” shall also be taken to include any tangible medium that is capable of storing, encoding, or carrying instructions for execution by the machine and that causes the machine to perform any one or more of the methodologies of embodiments of the present description, or that is capable of storing, encoding, or carrying data structures used by or associated with such instructions. The term “computer-readable storage medium” shall accordingly be taken to include, but not be limited to, solid-state memories, optical and magnetic media, and non-transitory machine-readable storage media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 524 may further be transmitted or received over a communications network 526 using a transmission medium via the network interface device 520 and utilizing any one of a number of well-known transfer protocols (e.g., HTTP). Examples of communication networks include a local area network (LAN), a wide area network (WAN), the Internet, mobile telephone networks. Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

It should be noted that various modifications and changes may be made to these example embodiments without departing from the broader spirit and scope of the present disclosure.

As used herein, the term “or” may be construed in either an inclusive or exclusive sense. Additionally, although various example embodiments discussed focus on a specific network-based environment, the embodiments are given merely for clarity in disclosure. Thus, any type of electronic system, including various system architectures, may employ various embodiments of the search system described herein and is considered as being within a scope of example embodiments.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore. Is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of the example embodiments as represented by the appended claims. The specification and drawings are, accordingly, to be regarded in an illustrative rather than a restrictive sense.

What is claimed is:

1. A computer-implemented method comprising:
determining material inventory from a plurality of physical locations;
determining material inventory usage settings of the material inventory from the plurality of physical locations; and
generating a tree data structure for usage of the material inventory from the plurality of physical locations based on the material inventory usage settings.

2. The computer-implemented method of claim 1, wherein the tree data structure comprises a root node sad a plurality of children nodes, the root node corresponding to a primary physical location, the plurality of children nodes corresponding to secondary physical locations distinct from the primary physical location.

3. The computer-implemented method of claim 2, wherein the material inventory usage settings include a breadth setting and a depth setting.

4. The computer-implemented method of claim 3, wherein the breadth setting comprises a priority setting corresponding to each branch of die tree data structure, wherein the depth setting comprises a use-up setting of a physical location.

5. The computer-implemented method of claim 4, wherein the priority setting includes a priority order for material inventory usage at corresponding physical location, wherein the use-up setting includes a depth inventory usage corresponding to a branch of the physical location.

6. The computer-implemented method of claim 5, further comprising:
receiving a material usage request;
traversing the tree data structure to locate material inventory from the plurality of physical locations to satisfy the material usage request using the material inventory usage settings;
identifying physical locations and corresponding material inventory usage; and
generating results comprising the identified physical locations and corresponding material inventory usage.

7. The computer-implemented method of claim 6, wherein traversing the tree data structure comprises:
traversing across the children nodes in an order according to their corresponding priority setting;
traversing down a branch of a child node after detecting a no use-up setting at the child node; and
traversing across the children nodes after traversing down the branch of the child node.

8. A system comprising:
a storage device configured to store material inventory from a plurality of physical locations and material inventory usage settings of the material inventory from the plurality of physical locations; and
a processor comprising a tree data structure generator configured to determine material inventory from the plurality of physical locations, to determine material inventory usage settings of the material inventory from the plurality of physical locations, and to generate a tree data structure for usage of the material inventory from the plurality of physical locations based on the material inventory usage settings.

9. The system of claim 8, wherein the tree data structure comprises a root node and a plurality of children nodes, the root node corresponding to a primary physical location, the plurality of children nodes corresponding to secondary physical locations distinct from the primary physical location.

10. The system of claim 9, wherein the material inventory usage settings includes a breadth setting and a depth setting.

11. The system of claim 10, wherein the breadth setting comprises a priority setting corresponding to each branch of the tree data structure, and wherein the depth setting comprises a use-up setting of a physical location.

12. The system of claim 11, wherein the priority setting Includes a priority order for material inventory usage at a corresponding physical location, and wherein the use-up setting includes a depth inventory usage corresponding to a branch of the physical location.

13. The system of claim 12, wherein the processor further comprises a material location module configured to receive a material usage request, to traverse the tree data structure to locate material inventory from the plurality of physical locations to satisfy the material usage request using the material inventory usage settings, to identify physical locations and corresponding material inventory usage, and to generate results comprising the identified physical locations and corresponding material inventory usage.

14. The system of claim 13, the material location module further configured to traverse across the children nodes in an order according to their corresponding priority setting, to traverse down a branch of a child node after detecting a no use-up setting at the child node, and to traverse across the children nodes after traversing down the branch of the child node.

15. A non-transitory machine-readable storage medium storing instructions which, when executed by at least one processor, performs operations comprising;
determining material inventory from a plurality of physical locations;
determining material inventory usage settings of the material inventory from the plurality of physical locations; and
generating a tree data structure for usage of the material inventory from the plurality of physical locations based on the material inventory usage settings.

16. The non-transitory machine-readable storage medium of claim 15, wherein the tree data structure comprises a root node and a plurality of children nodes, the root node corresponding to a primary physical location, the plurality of children nodes corresponding to secondary physical locations distinct from the primary physical location.

17. The non-transitory machine-readable storage medium of claim 16, wherein the material inventory usage settings include a breadth setting and a depth setting, the breadth setting comprising a priority setting corresponding to each branch of the tree data structure, the depth setting comprising a use-up setting of a physical location.

18. The non-transitory machine-readable storage medium of claim 17, wherein the priority setting includes a priority order for material inventory usage at a corresponding physical location, and wherein the use-up setting includes a depth inventory usage corresponding to a branch of the physical location.

19. The non-transitory machine-readable storage medium of claim 18, further comprising;
receiving a material usage request;
traversing the tree data structure to locate material inventory from the plurality of physical locations to satisfy the material usage request using the material inventory usage settings;
identifying physical locations and corresponding material inventory usage; and
generating results comprising the identified physical locations and corresponding material inventory usage.

20. The non-transitory machine-readable storage medium of claim 19, wherein traversing the tree data structure comprises:
traversing across the children nodes in an order according to their corresponding priority setting;
traversing down a branch of a child node alter detecting a no use-up setting at the child node; and
traversing across the children nodes after traversing down the branch of the child node.
